(19) United States
(12) Patent Application Publication
(10) Pub. No.: US 2004/0008168 A1
(43) Pub. Date: Jan. 15, 2004

(54) Car computer module

(76) Inventor: Ryan Chang, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/192,560

(22) Filed: Jul. 11, 2002

(51) Int. Cl. G09G 3/36

(52) U.S. Cl. 345/87

(57) ABSTRACT

A car computer module includes a casing having a guiding shaft and a teeth rod installed on each interior side of the casing, a liquid crystal display (LCD) screen stored within the casing and protruding from the casing, a first circuit unit connected to a rear part of the LCD screen for electrical connection to the LCD screen, a second circuit unit installed in the casing, and a CD/DVD ROM installed on the second circuit unit. The first circuit unit includes a driving device having a pair of active gears engaged with two associated teeth rods, whereby the first circuit unit is able to slide along the guiding shafts.

### BACKGROUND OF THE INVENTION

1. Field of the Invention

The present invention relates to a car computer module, and more particularly, to a car computer module with a pair of guiding shafts, active gears and teeth rods on two sides thereof for defining a stable mechanism to guide an LCD screen because the active gears are engaged with the teeth rods together.

2. Description of the Prior Art

As people spend more and more time in their cars, the car not only functions as a transportation means but also is expected to play as another tool for solving people's demands in work or life. The “e-trend” concept proposed by car manufacturers is to transform advanced information technologies into consumer-orientating field that supports the needs of car users. For example, in an aspect of entertainment, liquid crystal displays, VCD, video games, advanced stereo systems, DVD, MP3, or car navigation systems are usually selected by car users for the sake of driving pleasure.

Please refer to FIG. 1 of a prior art car computer module. As shown in FIG. 1, the prior art car computer module includes a casing 10 and a liquid crystal display (LCD) screen 11 movably installed with the casing 10. Normally, the LCD screen 11 is stored within the casing 10 if it is not in use. Otherwise, as illustrated, the LCD screen 11 is pulled out from the casing 10, hence users can read the information such as road map displayed on the screen 11. In some cases, the computer module further includes a VCD/DVD player.

However, the prior art car computer module has a drawback of unstableness for the LCD screen 11. According to the prior art, only one set of gears (not shown) for transmit of the LCD screen 11 is installed at one side of the LCD screen 11. Though, a commercial module on the market includes two sets of gears, or one guiding shaft (not shown) and one set of gears in total at two sides of the LCD screen 11, the aforementioned unstableness problem is still not solved properly. Moreover, the prior art computer module has an LCD circuit unit that is stacked on the LCD screen, therefore, occupying a large space.

### SUMMARY OF THE INVENTION

It is a primary objective of the present invention to provide a stable mechanism for guiding an LCD screen when it moves.

Another objective of the present invention is to provide a car computer module featuring in that an LCD screen and a first circuit unit are not stacked with each other, thus saving a great deal of space.

According to the claimed invention, a car computer module is provided. The car computer module includes a casing having a guiding shaft and a teeth rod installed on each interior side of the casing, a liquid crystal display (LCD) screen stored within the casing and capable of protruding from the casing, a first circuit unit connected to a rear part of the LCD screen for electrical connection to the LCD screen, a second circuit unit installed in the casing; and a CD/DVD ROM installed on the second circuit unit. The first circuit unit includes a driving device having a pair of active gears engaged with two associated teeth rods, whereby the first circuit unit is able to slide along the guiding shafts.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a schematic diagram of a prior art car computer module with an LCD screen.

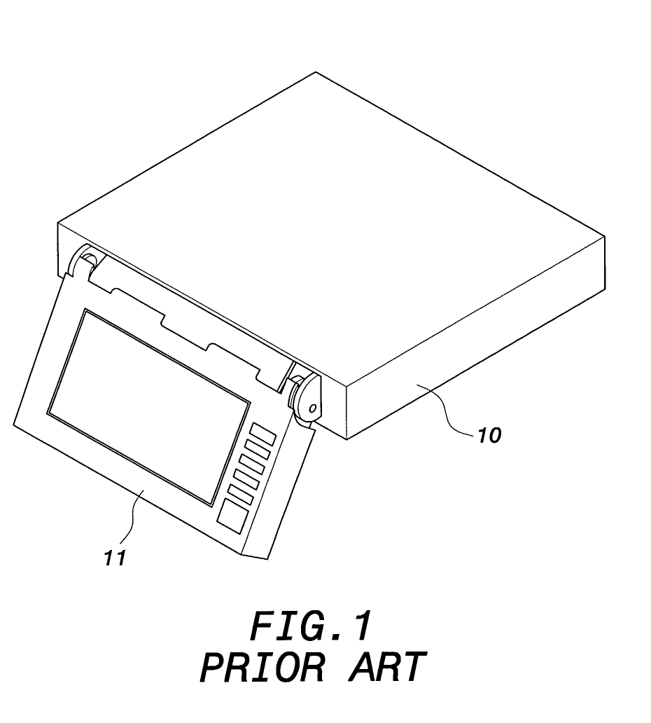

FIG. 2 is a schematic diagram of this invention.

FIG. 3 is an exploded diagram of this invention.

FIG. 4 is a side view of this invention.

FIG. 5 and FIG. 6 are diagrams illustrating the use of this invention.

### DETAILED DESCRIPTION OF THE PREFERRED EMBODIMENT

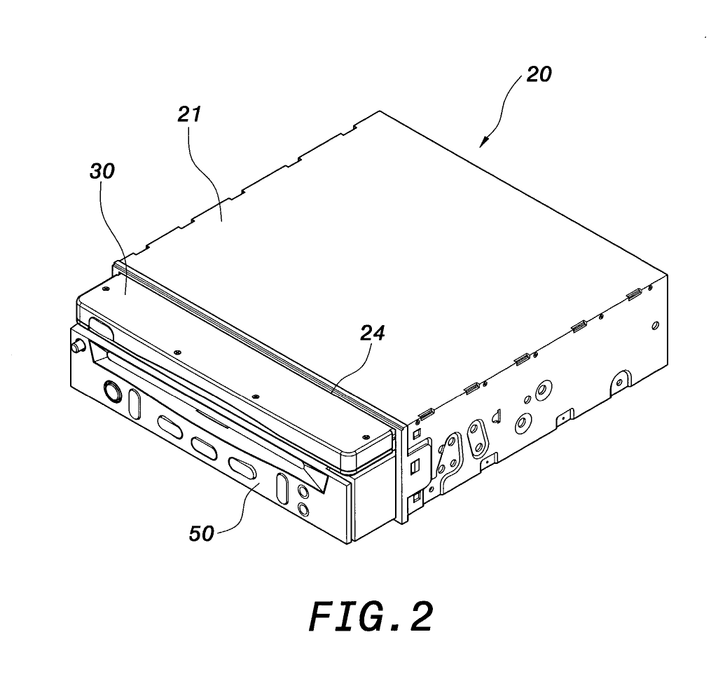

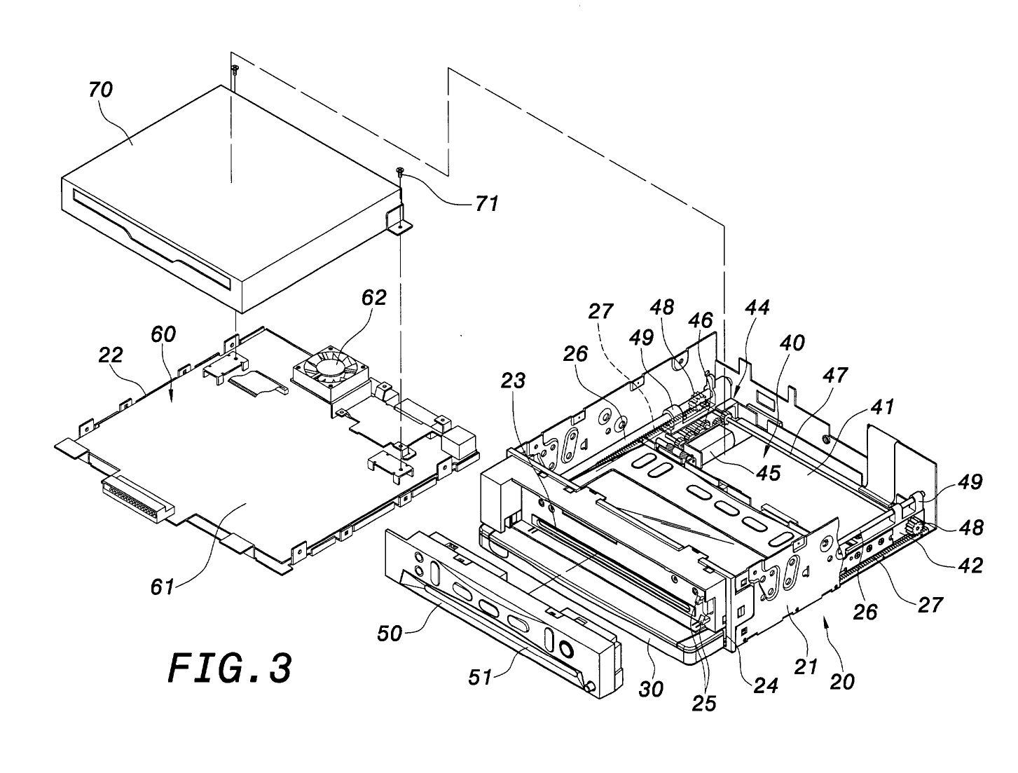

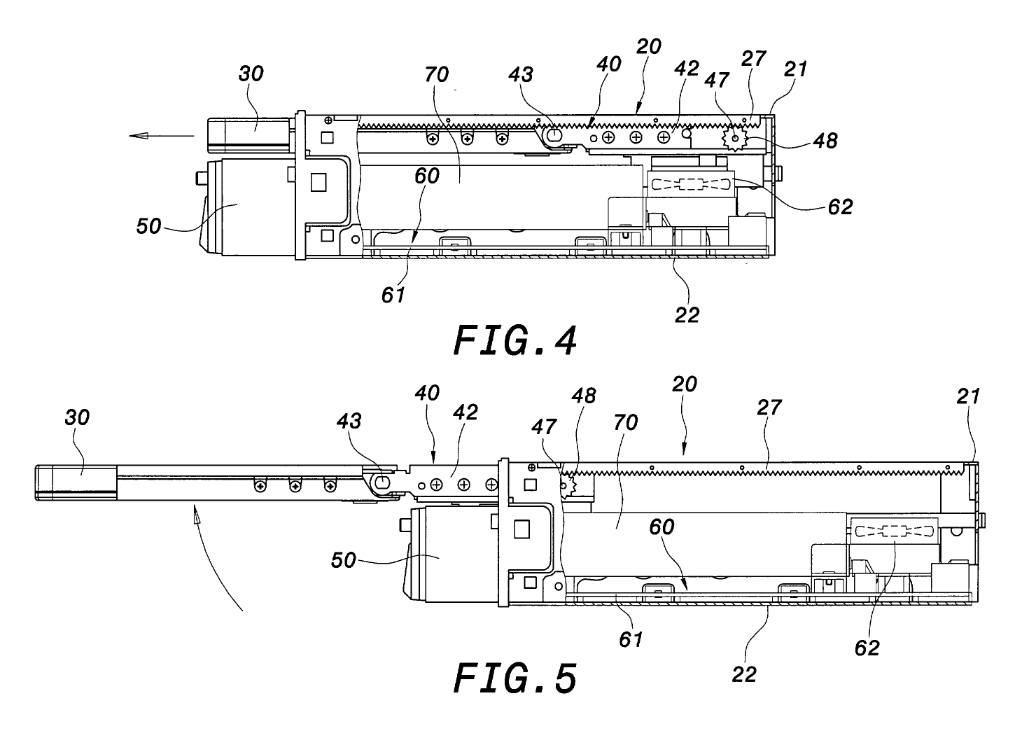

Please Refer to FIG. 2 through FIG. 4. FIG. 2 to FIG. 4 illustrate a car computer module according to the preferred embodiment of the present invention. As shown in FIG. 2 to FIG. 4, a car computer module of this invention includes a casing 20, an LCD screen 30, a first circuit unit 40, a control panel 50, a second circuit unit 60, and a CD-ROM or DVD-ROM 70. The casing 20 further includes a first casing 21 and a second casing 22, wherein the first casing 21 is normally installed about the second casing 22.The casing 20 provides a chamber therewithin and has an opening on its bottom portion. The second casing 22 is mounted on the bottom portion of the first casing 21. The first casing 21 has a CD opening 23 for entering/ejecting a compact disk at the front end thereof and an LCD opening 24 for storing the LCD screen 30. A plurality of snapping pieces 25 are provided around the front surface of the first half 21 for snapping the control panel 50. A guiding shaft 26 and an associated teeth rod 27 are provided on each of the two interior sides of the first casing 21. The guiding shaft 26 and the teeth rod 27 extend along the interior sides of the first casing 21.

The LCD screen 30 is movably installed in the casing 20 through the LCD opening 24. The LCD screen 30 may be pulled out of the casing 20 through the LCD opening 24.

The first circuit unit 40 includes a circuit board 41 and electric devices (not shown). The circuit board 41 and the electric devices are mounted on a substrate 42. The substrate 42 includes two pivot shafts 43 pivotally connected two sides of a front end thereof with two sides of the rear end of the LCD screen 30. The first circuit unit 40 is electrically connected with the LCD screen 30 by means known in the art. The first circuit unit 40 includes a control circuit for controlling operations of the LCD screen 30 and a driving circuit for driving the LCD screen 30 to move forwards and backwards.

A driving device 44 is installed on one side of the substrate 42. The driving device 44 includes a motor 45, a set of gears set 46, and a driving shaft 47. The motor 45 is tightly mounted on the substrate 42. The driving shaft 47 is pivotally installed on the substrate 42. The set of gears 46 is installed between the motor 45 and the driving shaft 47. An active gear 48 is mounted at each side of the driving shaft 47. The active gears 48 engage with the teeth rod 27 located at two interior sides of the casing 20.

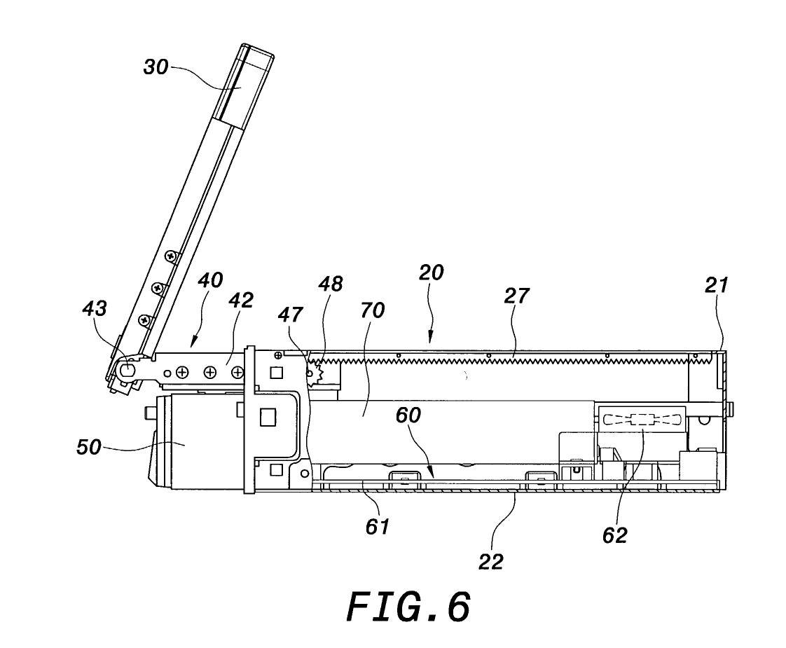

Two sliding bearings 49 are installed on the substrate 42 of the first circuit unit 40. The sliding bearings 49 slide along the guiding shafts 26. By this configuration, the driving motor 45 is able to drive the driving shaft 47 and the active gears 48 through the et of gears 46, thereby moving the first circuit unit 40 and the LCD screen 30. As best seen in FIG. 5, the LCD screen 30 protrudes from the LCD opening 24 for use; otherwise, the LCD screen 30 is stored within the casing 20. As seen in FIG. 6, the LCD screen 30 pivotally rotates by regarding the pivot shaft 43 as a fulcrum point.

The control panel 50 is detachably buckled at the front surface of the casing 20 by the snapping pieces 25. In a preferred embodiment, the control panel 50 is a button-type panel and includes circuit units for controlling operations of the LCD screen 30 and the CD-ROM 70. The control panel 50 has a CD opening 51 associated with the CD opening 23 for entering/ejecting compact disks.

The second circuit unit 60 includes a circuit board 61 and electric devices (not shown). The electric devices includes CPUs, memories, a global positioning system, or control software. The circuit board 61 and the electric devices are installed within the second casing 22 of the casing 20. A heat dissipation fan 62 is horizontally installed on the circuit board 61.

The CD-ROM or DVD-ROM 70 is locked on the circuit board 61 of the second circuit unit 60 by means of screws 71. As known by those skilled in the art, the CD-ROM 70 has a disk holder and reading device (both not shown). A compact disk may be entered/ejected from the CD-ROM 70 through the CD opening 51 of the control panel 50 and the CD opening 23 of the casing 20.

In short, the present provides a stable mechanism for guiding the LCD screen 30 when it moves by means of a pair of guiding shafts 26 and teeth rods 27. The LCD screen 30 and the first circuit unit 40 can move stably by the guiding of the two guiding shafts 26. Further, the LCD screen 30 and the first circuit unit 40 are not stacked, thus saving a great deal of space to facilitate the setting of whole computer module conveniently. Namely, the LCD screen 30, the first circuit unit 40 and the second circuit unit 60 create a multi-layer structure.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A car computer module, comprising:
a casing having a guiding shaft and a teeth rod installed on each two interior side therein;
a liquid crystal display (LCD) screen being stored within the casing and protruding from the casing;
a first circuit unit connected to a rear part of the LCD screen for being electrically connected to the LCD screen, the first circuit unit comprising a driving device having a pair of active gears engaging with two associated teeth rods, whereby the first circuit unit is slidably associated with the guiding shafts;
a second circuit unit installed within the casing; and
a CD/DVD ROM installed on the second circuit unit.

2. The car computer module of claim 1 wherein the casing comprises a first casing and a second casing, and wherein the first casing is installed about the second casing and has an opening at its bottom portion, and the second casing is connected to the bottom portion of the first casing.

3. The car computer module of claim 1 wherein the casing has an CD opening for entering/ejecting a compact disk at a front end thereof.

4. The car computer module of claim 1 wherein the casing has an LCD opening for storing the LCD screen.

5. The car computer module of claim 1 further comprising a plurality of snapping pieces on a front surface thereof for snapping a control panel having an CD opening for entering/ejecting a compact disk.

6. The car computer module of claim 1 wherein the guiding shafts and the teeth rods extend along the interior side of the casing.

7. The car computer module of claim 1 wherein the first circuit unit comprises a circuit board and electric devices mounted on a substrate, and the substrate comprises two pivot shafts pivotally connected two sides of a front end thereof with two sides of the rear end of the LCD screen.

8. The car computer module of claim 1 wherein a driving device is installed on one side of the first circuit unit, the driving device comprises a motor, a driving shaft having two ends thereof fixedly connected with the active gears, and a set of gears connected between the motor and the driving shaft.

9. The car computer module of claim 1 further comprising two sliding bearings installed on two sides of the first circuit unit for slidably associating with two guiding shafts.

10. The car computer module of claim 1 wherein the second circuit unit comprises a circuit board having a heat dissipation fan horizontally installed thereon.
